(19) United States
(12) Patent Application Publication
(10) Pub. No.: US 2018/0084933 A1
(43) Pub. Date: Mar. 29, 2018

(54) STRAW/STIRRER/CRUSHER

(71) Applicants: Artem Ishchenko, Sarasota, FL (US); Glenn Stepul, Wheeling, IL (US); Vladislav Kurbanov, Wheeling, IL (US); Igor Petryuchenko, Wheeling, IL (US)

(72) Inventors: Artem Ishchenko, Sarasota, FL (US); Glenn Stepul, Wheeling, IL (US); Vladislav Kurbanov, Wheeling, IL (US); Igor Petryuchenko, Wheeling, IL (US)

(21) Appl. No.: 15/276,622

(22) Filed: Sep. 26, 2016

(51) Int. Cl. A47G 21/18; A47J 43/10

(52) U.S. Cl. CPC A47G 21/181; A47J 43/10

(57) ABSTRACT

A straw/stirring/crushing device is provided. The straw/stirring/crushing device has a top, a bottom, a generally cylindrical shaft and a generally hollow interior. Located at the bottom of the straw/stirring/crushing device may be a generally flat base portion which may allow the straw/stirring/crushing device to stand upright. An opening at the bottom of the generally flat base portion may allow the device to intake a liquid while the device stands upright. A plurality of protrusions on the bottom of the generally flat base portion may allow the device to operate as a straw while resting at the bottom of a glass or cup. Further, the plurality of protrusions allow the device to act as a crusher for lemons, olives, ice or the like. In an embodiment, the device may have multiple openings for receiving a liquid located within a glass or cup.

### BACKGROUND OF THE INVENTION

A straw/stirring/crushing device is provided. The straw/stirring/crushing device has a top, a bottom, a generally cylindrical shaft and a generally hollow interior. Located at the bottom of the straw/stirring/crushing device may be a generally flat base portion which may allow the straw/stirring/crushing device to stand upright. An opening at the bottom of the generally flat base portion may allow the device to intake a liquid while the device stands upright. A plurality of protrusions on the bottom of the generally flat base portion may allow the device to operate as a straw while resting at the bottom of a glass or cup. Further, the plurality of protrusions allow the device to act as a crusher for lemons, olives, ice or the like. In an embodiment, the device may have multiple openings for receiving a liquid located within a glass or cup.

Unique straws have been invented in the past. For example, U.S. Pat. No. 4,228,913 to Mack discloses a tab top can having a self-contained drinking straw. The straw includes a resilient bellows structure on its bottom which serves to bias the top end of the straw against the underside of the tab top. A straw guide secured on the interior of the can aligns the top end of the straw with the underside of the tab top. The bellows structure forces the top end of the straw through the drinking slot formed when the tab top is removed from the can.

Further, U.S. Pat. No. 4,109,817 to Payne discloses a straw assembly for a liquid container having a pull-tab closure over an opening in its top. Removal of the closure allows the straw which is collapsed within the container and has a float mounted on its bottom end, to rise through the opening where it is manually extended to its full length. One embodiment includes the straw being slidably journaled within a tube mounted on the inner wall of the container. Another embodiment includes a straw guide assembly which positions the straw within the container in registry with an opening centrally disposed through the container top.

Still further, U.S. Pat. No. 8,042,701 to Raman discloses an integrated bottle enclosure having a top cap, bottom cap, rigid straw casing and telescoping straw assembly to provide efficient means to contain a straw within a sealed bottle. Opening the top cap presents a straw ready for immediate use, or the straw may be grasped and pulled, to reveal ample straw length for keeping a consumer's mouth away from the bottle. The top cap and bottom cap connect by means to create a secure straw vault which prevents fluid from leaking out of the straw.

However, these straws fail to provide a straw/stirrer/crusher which is easy to use and efficient as in the present application. A need, therefore, exists for an improved straw/stirrer/crusher.

### SUMMARY OF THE INVENTION

A straw/stirring/crushing device is provided. The straw/stirring/crushing device has a top, a bottom, a generally cylindrical shaft and a generally hollow interior. Located at the bottom of the straw/stirring/crushing device may be a generally flat base portion which may allow the straw/stirring/crushing device to stand upright. An opening at the bottom of the generally flat base portion may allow the device to intake a liquid while the device stands upright. A plurality of protrusions on the bottom of the generally flat base portion may allow the device to operate as a straw while resting at the bottom of a glass or cup. Further, the plurality of protrusions allow the device to act as a crusher for lemons, olives, ice or the like. In an embodiment, the device may have multiple openings for receiving a liquid located within a glass or cup.

An advantage of the present straw/stirrer/crusher is that the present device may be utilized as a straw.

Another advantage of the present straw/stirrer/crusher is that the present device may be used as a stirrer.

Still another advantage of the present straw/stirrer/crusher is that the present device may be used as a crusher.

And another advantage of the present straw/stirrer/crusher is that the present device may freely stand upright within a drink.

Yet another advantage of the present straw/stirrer/crusher is that the present device has at least one opening for the intake of liquids located at the bottom of a generally flat base portion.

Still another advantage of the present straw/stirrer/crusher is that the present device may have a plurality of protrusions located on the bottom of a generally flat base portion wherein the plurality of protrusions elevate the generally flat base portion so that an opening on the bottom of the straw/stirrer/crusher may access liquid in a glass.

For a more complete understanding of the above listed features and advantages of the present straw/stirrer/crusher, reference should be made to the drawings. Further, additional features and advantages of the invention are described in, and will be apparent from, the detailed description of the preferred embodiments.

### BRIEF DESCRIPTION OF THE DRAWINGS

FIG. 1 illustrates a perspective view of the straw/stirrer/crusher in a first embodiment.

FIG. 2 illustrates a front perspective view of the bottom base of the straw/stirrer/crusher in the first embodiment.

FIG. 3 illustrates a side plan view of the straw/stirrer/crusher in the first embodiment.

FIG. 4 illustrates a side plan view of a smaller straw/stirrer/crusher in the first embodiment.

FIG. 5 illustrates a top view of the straw/stirrer/crusher in the first embodiment.

FIG. 6 illustrates a bottom view of the straw/stirrer/crusher in the first embodiment.

FIG. 7 illustrates a perspective view of the straw/stirrer/crusher in a second embodiment.

FIG. 8 illustrates a side view of the straw/stirrer/crusher in the second embodiment.

FIG. 9 illustrates a side plan view of the straw/stirrer/crusher in a third embodiment wherein the device is located within a glass.

FIG. 10 illustrates an alternative embodiment fourth embodiment of the straw/stirrer/crusher wherein the straw portion is elevated above the generally flat base portion.

FIG. 11 illustrates the fourth alternative embodiment of the straw/stirrer/crusher wherein the bottom of the device is being used to crush a lemon in a glass.

### DETAILED DESCRIPTION OF THE PREFERRED EMBODIMENTS

A straw/stirring/crushing device is provided. The straw/stirring/crushing device has a top, a bottom, a generally cylindrical shaft and a generally hollow interior. Located at the bottom of the straw/stirring/crushing device may be a generally flat base portion which may allow the straw/stirring/crushing device to stand upright. An opening at the bottom of the generally flat base portion may allow the device to intake a liquid while the device stands upright. A plurality of protrusions on the bottom of the generally flat base portion may allow the device to operate as a straw while resting at the bottom of a glass or cup. Further, the plurality of protrusions allow the device to act as a crusher for lemons, olives, ice or the like. In an embodiment, the device may have multiple openings for receiving a liquid located within a glass or cup.

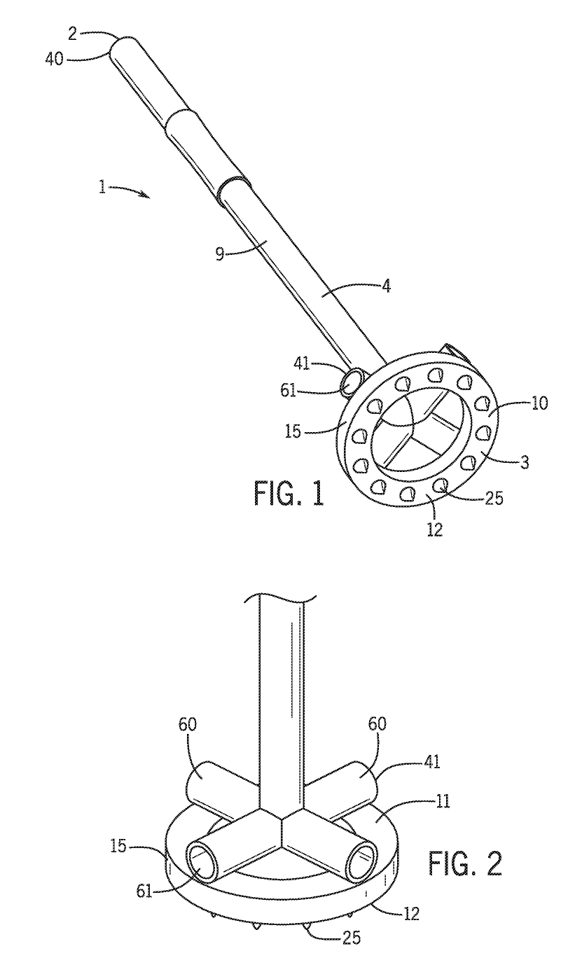

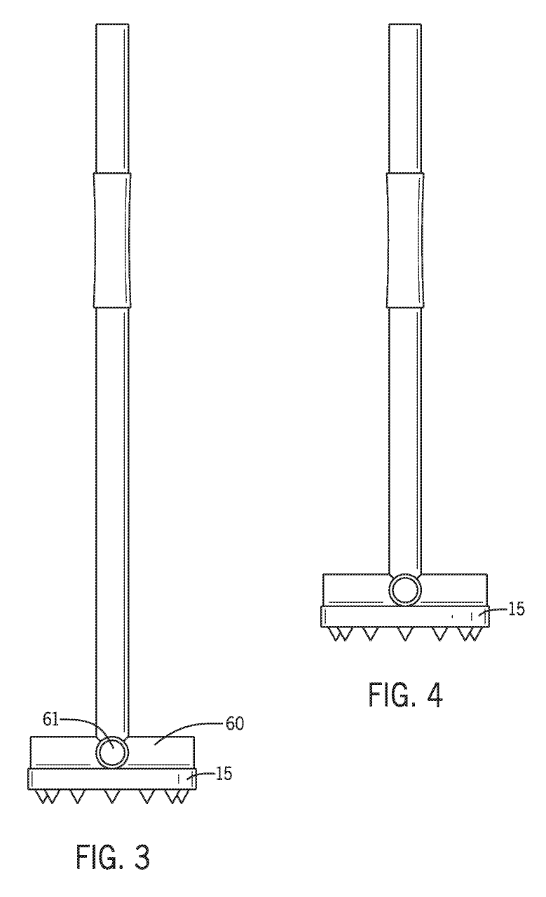

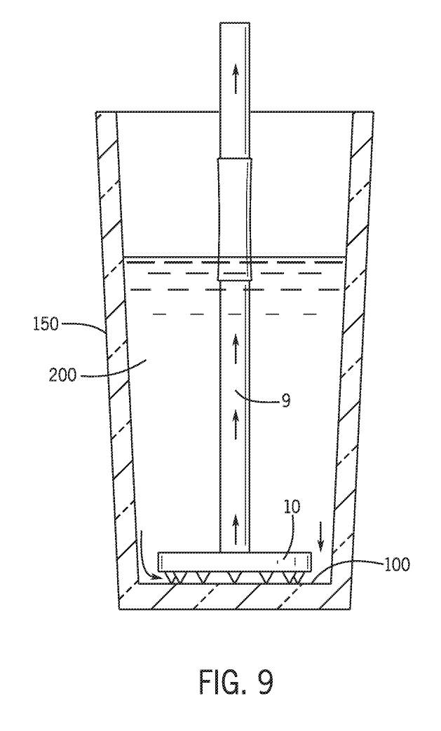

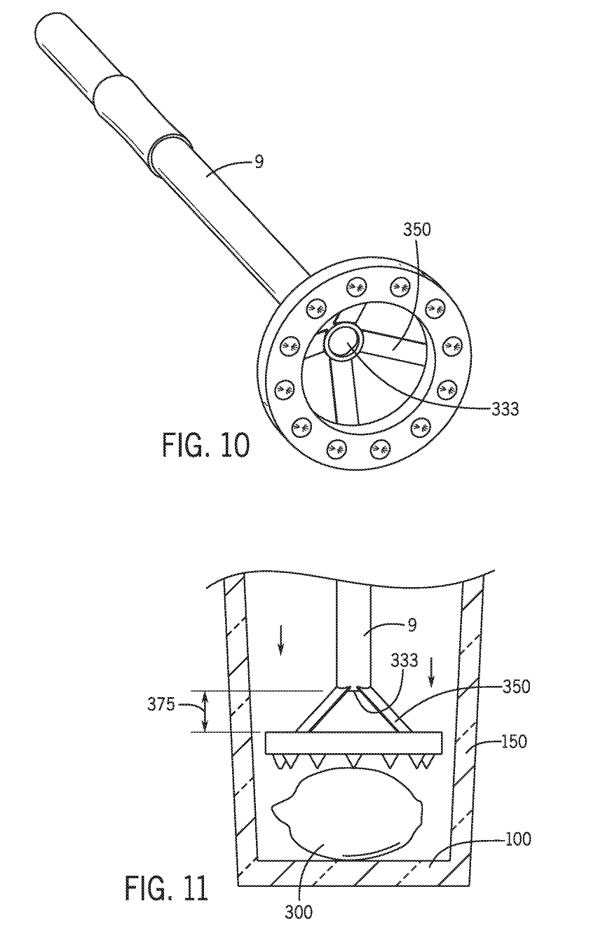

Referring first to FIG. 1, in a first embodiment, a straw/stirrer/crusher 1 is provided. In particular, the device 1 may have a straw component and a crusher component and wherein the device may also be used as a stirrer. The straw/stirrer/crusher 1 may have a top 2, a bottom 3 and a generally cylindrical shaft portion 4 having a generally hollow interior 5 (FIG. 8). Preferably, the length of the straw/stirrer/crusher 1 is similar to the length of other standard sized straws (FIGS. 3 and 4 show variations of the sizes based on standard sized straws). In an embodiment, the device 1 is preferably made of plastic, but may be made of any suitable material. The device 1 is especially suitable for pulling upward on a liquid 200 (FIG. 9) located within a glass or cup 150 up to a user.

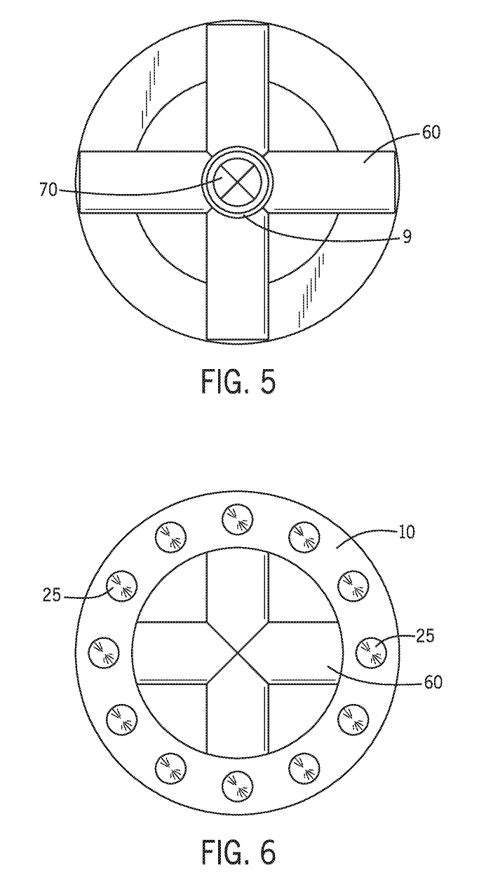

The straw/stirrer/crusher 1 may have a straw portion 9 and a generally flat base portion 10 wherein the generally flat base portion 10 is located below and permanently connected to the straw portion 9. The generally cylindrical base portion 10 may allow the straw portion (and therefore the entire device 1) to stand upright (FIG. 9) within the glass or cup 150 and may further be used to crush the object 300. The straw portion 9 may have a first end 40 and a second end 41 wherein the first end 40 of the straw portion 9 may have an opening 70 (FIG. 5) and may be the portion of the straw that a user places his/her lips on.

In an embodiment the generally flat base portion 10 is circular and may have a top 11 (FIG. 2), a bottom 12, and a cylindrical exterior side portion 15. Preferably, the generally flat base portion 10 is large enough so as to allow the device 1 to stand upright, but small enough so as to fit into the opening of the glass or cup 150. The second end 41 of the straw portion 9 may be permanently connected to and, in an embodiment, in fluid communication with the generally flat base portion 10. In particular, the second end 41 of the straw portion 9 may have an opening 61 for receiving the liquid 200.

In the first embodiment (FIGS. 1-6) the second end 41 of the straw portion 9 may have a plurality of side tubes 60. The side tubes 60 may be generally perpendicular with respect to the main straw portion 9. Although FIGS. 1-6 illustrate four side tubes 60 being utilized, a greater number or fewer number of side tubes 60 may be utilized in the device 1. In an embodiment, each of the side tubes 60 may have an opening 61 (as discussed above) which is internally connected to the generally hollow interior 5 of the straw portion 9 and therein allows the liquid 200 to pass first through the side tubes 60 and then up straw portion 9 to the user.

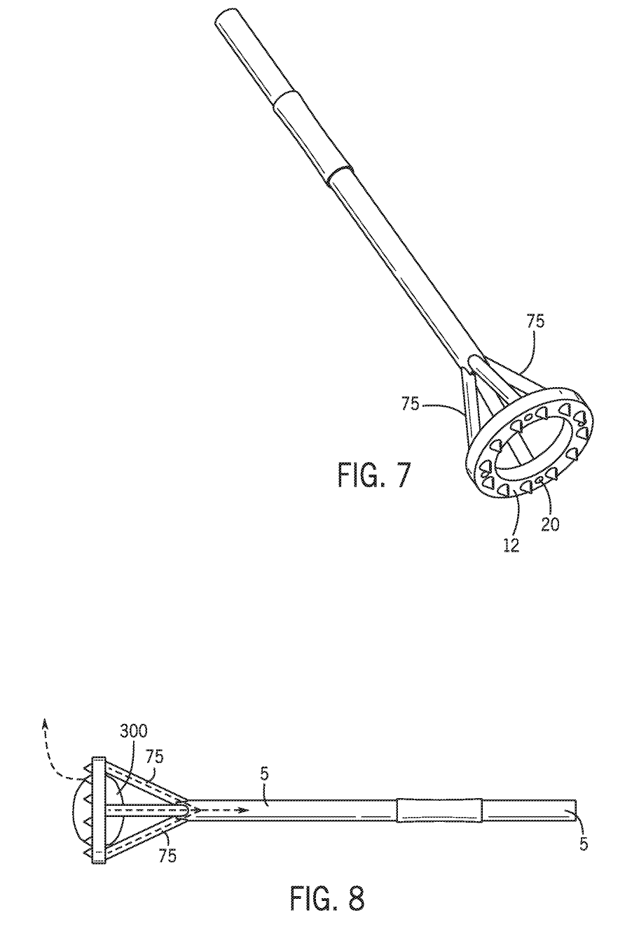

Referring now to FIGS. 7 and 8, in an alternative embodiment, the device 1 may not utilize perpendicular side tubes 60, but may instead utilize a plurality of angled hollow support tubes 75 connected to the generally flat base portion 10. The angled hollow support tubes 75 may have an opening 20. In this embodiment, the openings 20 of the hollow support tubes 75 may be located actually on the bottom 12 of the generally flat base portion 10 (as opposed to located above the bottom of the generally base portion as illustrated in FIG. 1). More specifically, in the embodiment of FIGS. 7 and 8, the hollow tube portion for which the liquid 200 passes through actually goes through the generally flat base portion 10 whereas in FIGS. 1-6 the liquid 200 does not actually pass through the generally flat base portion 10. Angling the hollow support tubes 75 in this embodiment, also allows a user to trap an object 300 (such as a lemon, olive or other condiment) at the bottom of a drink so that the object interacts with the liquid 200 more and produces a stronger flavor. This is illustrated in FIG. 8 wherein an olive is trapped beneath the angled hollow support tubes 75.

In an embodiment, the bottom 12 of the generally flat base portion 10 may have a plurality of protrusions 25. In an embodiment (as illustrated in FIGS. 8 and 9) the plurality of protrusions 25 may be generally semi-spherical or cone shaped. The plurality of protrusions 25 may elevate the bottom 12 of the generally flat base portion 10 off the interior bottom surface 100 of a glass or cup 150 so that the openings 20 on the bottom 12 of the generally flat base portion 10 does not directly touch the interior bottom surface 100 of the glass or cup 150 and therein prevent the liquid 200 from gaining access to the opening 20 (as would otherwise happen in embodiments two and three). In an embodiment, the plurality of protrusions 25 may elevate the generally flat base portion 10 approximately one-eighth of an inch to one inch off the interior bottom surface 100 of the glass or cup 150. Preferably, the lower the generally flat base portion 10 sits within the glass or cup 150 to more liquid 200 the device 1 may ultimate be able to pull up through the device 1.

In still an alternative embodiment, as illustrated in FIG. 9, the device 1 may lack both side tubes 60 and the angled hollow support tubes 75 and instead may utilize a single opening (not visible) located at the second end 41 of the straw portion 9 wherein the straw portion 9 extends to the generally flat base portion 10.

As stated above, the device 1 may be utilized as a straw, a crusher and a stirrer. To use the device 1 as a straw, the user may grab the generally cylindrical shaft portion 4 and suck on the top 2 of the straw portion 9 or a user may allow the device 1 to stand upright on its own (FIG. 9) while sucking on the straw portion 9. To utilize the device 1 as a stirrer, the user may move the device 1 around within the interior of the glass or cup 150 to mix a drink.

Referring now to FIG. 11, in an embodiment, the bottom 3 of the straw/stirrer/crusher 1 may also be used to crush an object 300. In particular, the straw/stirrer/crusher 1 may be used to crush, for example, a lemon or olive located at the bottom of the glass or cup 150 to add flavor to the drink. In particular, the bottom 3 of the generally flat base portion 10 of the device 1, including a plurality of protrusions 25 may be used to crush the object 300 by squeezing the object 300 between the bottom 3 of generally flat base portion 10 of the device 1 and the interior bottom surface 100 of the glass or cup 150. In an embodiment, the bottom 3 of the generally flat base portion 10 of the device 1 may also be used to crush ice.

Finally, in an alternative embodiment as illustrated in FIG. 11, an opening 333 of the straw portion 9 of the device 1 (which intakes the liquid) may be elevated a distance 375 above the generally flat base portion 10 so that seeds or pits from objects 300, or even ice, etc will be less likely to become sucked up into the opening 333 of the device 1 as a result of the opening 333 being located farther away from the interior bottom surface 100 of the glass or cup 150. A plurality of supports 350 may be used to elevate the straw portion 9 of the device 1 so that the opening 333 of the bottom 41 of the straw portion 9 is above the generally flat base portion 10 of the device 1.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

1) A straw having a base comprising:
a shaft portion having an axis and the shaft having a first end, a second end and a generally hollow interior;
an opening located at the first end of the shaft portion and an opening at the second end of the shaft portion;
a base portion located at the second end of the shaft portion wherein the base portion is connected to the shaft portion;
wherein the base portion supports the shaft portion and is capable of allowing the shaft portion to stand up-right;
a plurality of independent side tubes attached to the second end of the shaft portion wherein the plurality of independent side tubes each have a first end having an opening and a second end having an opening and wherein the plurality of independent side tubes each have a length defined as the distance between the first end and the second end and wherein the plurality of independent side tubes have a hollow interior; and
wherein the opening of the first end of the plurality of independent tubes is connected to the shaft portion and wherein the opening of the second end of the plurality of independent tubes is located distal from the shaft portion and wherein a liquid is capable of passing first through the hollow interior of the plurality of independent side tubes and then through the hollow interior of the shaft portion.

2) The straw having a the base of claim 1 further comprising:
a top of the base portion and a bottom of the base portion wherein the bottom of the base portion has a plurality of protrusions.

3) The straw having a the base of claim 2 wherein the plurality of protrusions are cone-shaped.

4) (canceled)

5) The straw having the base of claim 1 wherein the plurality of side tubes are perpendicular relative to the axis of the shaft portion.

6) The straw having the base of claim 1 wherein the plurality of side tubes are angled relative to the axis of the shaft portion.

7) (canceled)

8) The straw having the base of claim 1 further comprising:
at least one opening located on a bottom of the base portion wherein the opening extends through the base portion and to the second end of the shaft portion.

9) The straw having the base of claim 1 wherein the straw is made of plastic.

10) A straw having a base comprising:
a shaft portion having an axis and the shaft having a first end, a second end and a generally hollow interior;
an opening located at the first end of the shaft portion and an opening at the second end of the shaft portion;
a base portion having a top and a bottom wherein the base portion is located at the second end of the shaft portion; and
a plurality of supports connecting the top of the base portion to the second end of the shaft portion wherein the plurality of supports elevates the opening of the second end of the shaft portion above the top of the base portion and wherein a space is created between the opening of the second end of the shaft portion and the top of the base portion and wherein the space is capable of securing a food article or ice at least partly above the top of the base portion and below the shaft portion.
